(19) United States
(12) Patent Application Publication
(10) Pub. No.: US 2010/0250707 A1
(43) Pub. Date: Sep. 30, 2010

(54) ELECTRONIC CONCIERGE

(75) Inventors: Christopher B. Dalley, Riverton, UT (US); Chad Sly, West Jordan, UT (US)

Correspondence Address: SNELL & WILMER L.L.P. (Main), 400 EAST VAN BUREN, ONE ARIZONA CENTER, PHOENIX, AZ, 85004-2202, US

(73) Assignee: GUESTSPAN, LLC, Riverton, UT (US)

(21) Appl. No.: 12/415,498

(22) Filed: Mar. 31, 2009

(51) Int. Cl. G06F 15/16

(52) U.S. Cl. 709/219

(57) ABSTRACT

Various embodiments of the invention provide a method of enhancing a user's stay at a facility. The method may comprise aggregating information specific to the user together with other information in order to create recommendation information. The method may further comprise providing an option to the user based upon the recommendation information and associated facility information. The method may further comprise using a selection made by the user in order to provide an option to a second user. Further embodiments of the invention provide an electronic concierge system that comprises a server configured to communicate server information to a display on at least one user terminal. The electronic concierge system may be configured to receive a user request from a user terminal and transmit information to the user terminal in response to the request. The user terminal information may be configured to be based at least in part on aggregated user information. Still other embodiments of the invention comprise a computer-readable medium having stored thereon a plurality of instructions, the plurality of instructions comprising instructions to accomplish the various methods disclosed herein.

### FIELD OF INVENTION

This disclosure is related to an electronic information provider, and more specifically, to an electronic information provider configured to provide and receive information associated with a facility user.

### BACKGROUND OF THE INVENTION

A traveler arrives in a city he has never visited. It is late at night and a cab drops him off at a hotel. The traveler checks in, walks to his room, collapses on the bed and realizes he hasn't eaten anything for several hours. He rolls over to the end table, picks up the hotel information book and quickly flips to the restaurant section. He sees the hotel's restaurant and names and addresses for a number of other restaurants. But because he doesn't know the area, he leaves the room to find the hotel's restaurant. His mouth starts watering as he approaches the restaurant, but it dries up immediately when he discovers the restaurant is closed. He walks outside the hotel in hopes of seeing a nearby restaurant, but sees nothing because it's dark and tall trees surround the hotel. The concierge's desk is empty when he passes it. He talks with a hotel employee who recommends one of the traveler's least favorite places to eat, so he moves on. He ends up settling for room service.

Little did the traveler know, a favorite restaurant of his from another city also had a restaurant a short cab ride away from the hotel. Because it is only a small restaurant, and a little out of walking distance, it did not show up in the hotel's information book. Throughout the traveler's stay at the hotel, he never discovers this restaurant. Consequently, the traveler also did not discover that his favorite restaurant provides delivery service to the hotel.

During his week-long business trip, the traveler hungers for social interactions outside of his mundane business interactions. He tries to strike up conversations with other hotel-dwellers, but happens to find only those with interests completely unlike his own. Little did the traveler know, but the person staying in the room right across the hall from him was also looking for social interaction and shared many of the same interests as the traveler. Also, a club of the type the traveler likes to frequent was only a short cab ride away. An entertainment facility near the hotel that is often visited by other hotel-dwellers was also never made known to the traveler.

After his busy week, the traveler returns home to his family. He sees his smiling daughter waiting for him on the front porch. After greeting his daughter, he proceeds to put his things away. A few minutes later, he hears his daughter crying and remembers, all of a sudden, that today was her birthday. The traveler's mind had been preoccupied and he had forgotten to get his daughter a birthday present.

Although the above scenario is by no means exhaustive of the various disadvantages a traveler has while staying in an unknown city, at present there is no single device that is capable of remedying the above and other situations. Therefore, it is desirable to provide access to an electronic concierge system at various facilities such as hotels that is configured to facilitate an enhanced experience of a user of the system and to remedy the above and other disadvantages.

### SUMMARY OF THE INVENTION

While the ways in which the present invention addresses the disadvantages of the prior art will be discussed in greater detail below, a general summary is provided here. Various embodiments of the invention provide a method of enhancing a user's stay at a facility, such as a hotel, hospital, resort, and the like. The method may comprise aggregating information specific to the user together with other information in order to create recommendation information, or information upon which to make recommendations to the user. The method may further comprise associating the recommendation information with facility information, and providing an option to the user based upon the recommendation information that was associated with the facility information. Such a method may result in the enhancement of the user's stay at the facility because of the specific options that are provided to the user. The method may further comprise using a selection made by the user in order to provide another option to a second user.

Further embodiments of the invention provide an electronic concierge system that comprises a server configured to communicate server information to at least one user terminal, wherein the at least one user terminal may be configured to display the server information. The electronic concierge system may further comprise a network connection configured to receive a user request from a specific user terminal and transmit user terminal information to the specific user terminal in response to the user request. The user terminal information may be configured to be based at least in part on aggregated user information, and the user terminal information may further be configured to be displayed on the specific user terminal.

Still other embodiments of the invention comprise a computer-readable medium having stored thereon a plurality of instructions, the plurality of instructions comprising: instructions to aggregate first user-specific information and other information to create recommendation information; instructions to associate the recommendation information with facility information; instructions to provide a first user option in response to the instructions to associate the recommendation information with the facility information; instructions to receive a first user selection in response to the instructions to provide the first user option; instructions to update the first user-specific information in response to the instructions to receive the first user selection; instructions to update the other information in response to the instructions to receive the first user selection; instructions to aggregate second user-specific information and the other information to create second recommendation information; instructions to associate the second recommendation information with second facility information; instructions to provide a second user option to a second user in response to the instructions to associate the second recommendation information with the second facility information; instructions to receive a second user selection in response to the instructions to provide the second user option; instructions to update the second user-specific information in response to the instructions to receive the second user selection; and instructions to update the other information in response to the instructions to receive the second user selection.

### BRIEF DESCRIPTION OF THE DRAWINGS

In order that the manner in which the above-recited and other features and advantages of the invention are obtained will be readily understood, a more particular description will be rendered by reference to specific examples of embodiments thereof which are illustrated in the appended drawings. These drawings depict only typical examples of embodiments of the invention and are not therefore to be considered to limit the scope of the claimed invention.

FIG. 1 illustrates a perspective view of a terminal according to an embodiment of the present invention.

FIG. 2 illustrates a front plan view of a terminal according to an embodiment of the present invention.

FIG. 3 illustrates a front plan view of a housekeeping screen according to an embodiment of the present invention.

FIG. 4 illustrates a front plan view of another housekeeping screen according to an embodiment of the present invention.

FIG. 5 illustrates a front plan view of a room service screen according to an embodiment of the present invention.

FIG. 6 illustrates a front plan view of a wake up call screen according to an embodiment of the present invention.

FIG. 7 illustrates a front plan view of another wake up call screen according to an embodiment of the present invention.

FIG. 8 illustrates a front plan view of a weather screen according to an embodiment of the present invention.

FIG. 9 illustrates a front plan view of a hotel information screen according to an embodiment of the present invention.

FIG. 10 illustrates a front plan view of an entertainment screen according to an embodiment of the present invention.

FIG. 11 illustrates a front plan view of a special offers screen according to an embodiment of the present invention.

FIG. 12 illustrates a front plan view of a survey screen according to an embodiment of the present invention.

FIG. 13 illustrates a front plan view of a languages screen according to an embodiment of the present invention.

FIG. 14 illustrates a network diagram of a system according to an embodiment of the present invention.

FIG. 15 illustrates a flow chart of a method according to an embodiment of the present invention.

### DETAILED DESCRIPTION

The following description is of exemplary embodiments of the invention and is not intended to limit the scope or applicability of the invention in any way. Rather, the following description is intended to provide convenient illustrations for implementing various embodiments of the invention. Other configurations, materials, shapes, designs, and the like may be employed without departing from the scope of the present invention. As will become apparent, various other changes may be made to the methods described in these embodiments without departing from the spirit and scope of the invention.

Various embodiments of the present invention are related to an electronic concierge system located in a hospitality facility such as a hotel or a resort. Other embodiments of the invention comprise a terminal for use by a guest of any number of types of facilities, such as hospitals, restaurants, sports venues, shopping centers, community facilities such as community recreation centers, entertainment facilities, airports, time shares, condo properties, cruise ships, luxury resorts, or any other property where people may reside while away from their normal residence. Still other embodiments of the invention comprise terminals that may be located anywhere users of the terminals may visit. Therefore, although the electronic concierge system may be described in relation to a hotel, it should be understood that the use of the electronic concierge system is not limited to use within hotels or any other specific location disclosed herein.

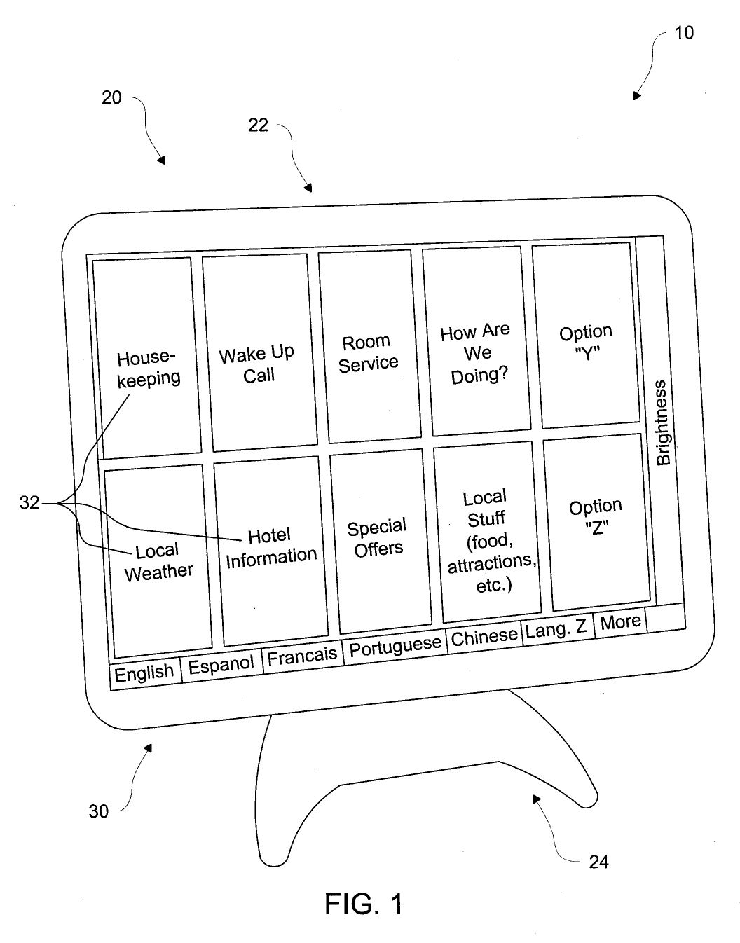

With reference to FIG. 1, the electronic concierge system comprises a terminal 10 that comprises a housing 20 and a display 30. Not shown in FIG. 1, terminal 10 further comprises a computer configured to control the operation of terminal 10. Elements of computing systems and the computer of terminal 10 are well known in the art and will be discussed briefly below. Housing 20 comprises various components that are configured to give structure to housing 20. Display 30 comprises various icons and other options configured to facilitate the use and/or configuration of terminal 10 by a user. In other embodiments, terminal 10 may comprise various peripheral devices such as a keyboard, mouse, speaker, printer, microphone, telephone, camera, USB port, MP3 player input, and the like. But in still other embodiments, these and other peripheral devices may be contained within terminal 10 and may not be separate devices.

In accordance with various embodiments, housing 20 may comprise a number of structural components. For example, housing 20 may comprise a display case 22 configured to house display 30. Housing 20 may further comprise a base 24 configured to provide support for terminal 10. Display case 22 and base 24 may comprise any configuration that provides the functionality of display case 22 and base 24 disclosed herein. Housing 20 may further comprise components such as a computer case configured to house various computing components of terminal 10. Housing 20 may also comprise buttons, knobs, switches and the like to facilitate navigating through the screens and options available through terminal 10. In other embodiments, the computing components of terminal 10 may be configured to be contained with display case 22 and/or base 24. In still other embodiments, other peripheral devices may be used in connection with housing 20 in order to provide the functionality of terminal 10 as disclosed herein. Terminal 10 may be powered by any means now known or that is developed in the future, such as AC power, DC power, battery power, solar power, and the like. In certain embodiments, terminal 10 may be hard wired into the power of a facility in order to reduce the chance that a user may disconnect terminal 10 from the power supply. In some embodiments, terminal 10 may be secured to the facility room via a securing device, such as a locking bracket, that the facility staff is able to remove, but that a facility user is not able to remove.

Further embodiments of the invention comprise display 30 that is configured to facilitate interaction between a user and terminal 10. Display 30 may comprise an icon 32 or plurality of icons 32 that are configured to allow a user to choose the aspects of terminal 10 with which he wishes to interact. Display 30 may comprise a liquid crystal display (LCD), a cathode ray tube (CRT) display, a plasma display, a television display, a projection display, a handheld display, and/or any type of graphical display. In other embodiments, display 30 may comprise an audio display such that the user may hear icons 32 represented as sound, with or without seeing icons 32, and the user may interact with terminal 10 by responding vocally. For example, the microphone and speakers of terminal 10 may allow a guest at a hotel to interact with the hotel staff and local community vocally, for example, via voice recognition devices and/or software. In other embodiments, terminal 10 may allow users of a facility to communicate with other users of the facility, and it may allow the users to conduct conference calls through terminals in various parts of the facility.

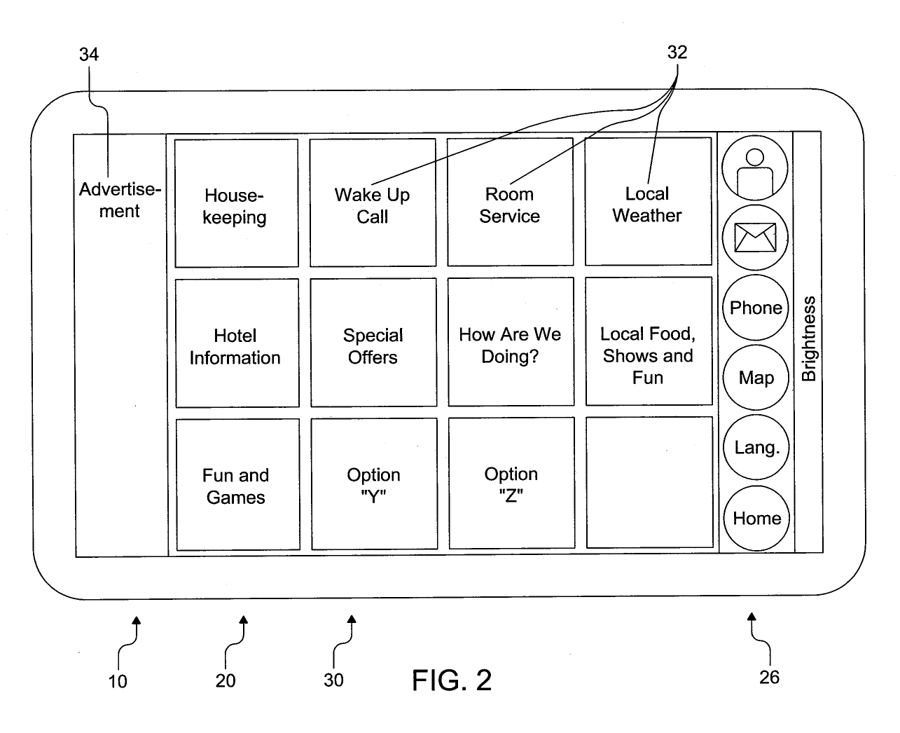

In certain embodiments, display 30 may comprise a touch screen interface such that a user may select various icons 32 and/or input information into terminal 10 by touching display 30. In other embodiments, terminal 10 may comprise peripheral devices such as a keyboard, mouse, pointer, and the like to facilitate the interaction of the user with terminal 10. In still other embodiments, and with reference to FIG. 2, housing 20 may comprise navigation tools 26 configured to allow the user to navigate icons 32 and otherwise interact with terminal 10.

According to still other embodiments of the invention, terminal 10 is configured to allow communication between different people, parties, entities and/or groups of people, parties and/or entities. For example, terminal 10 may be configured to allow a facility user to communicate with facility staff, such as, with respect to a hotel facility, requesting wake-up calls, room services, property maps, amenity listings, check out services, and bill review. Terminal 10 may further be configured to allow a facility to communicate with a facility user, such as, with respect to a hotel, requesting user surveys, aggregation of user preferences, and maintenance of personal user accounts. Terminal 10 may further be configured to allow a facility user to communicate directly with facility staff to facilitate certain requests such as hotel housekeeping requests and other supply and/or maintenance requests. Terminal 10 may further be configured to allow the facility staff to present messages to the facility users to provide, for example, status updates on certain user requests. Terminal 10 may further be configured to allow a facility user to communicate with the community surrounding the facility, for example convenience stores, medical offices, entertainment locations, restaurants, and any type of entity that may exist in the community surrounding the facility. For example, maps, recommendations, entertainment wizards and/or suggestions, advertising, special offers and other items may be communicated between the facility user and the community via terminal 10.

With continued reference to FIG. 2, various embodiments of terminal 10 comprise a number of icons 32. In an embodiment where terminal 10 is located in a hotel, icons 32 may provide hotel guests a complete portal for all the guests' needs while they are at the hotel. Through interaction with terminal 10, guests may be able to replicate substantially all interaction with the hotel staff, housekeeping personnel and the local community. For example, display 30 of terminal 10 may comprise any, all, or a combination of the following: a housekeeping icon, a wake up call icon, a room service icon, a weather icon, a hotel information icon, a special offers icon, a survey icon, an entertainment icon, a guest information icon, a guest account icon, a messages icon, an email icon, a languages icon, a social interaction icon, a telephone icon, an Internet icon, and a games icon. Any number of other icons or choices may be used depending on the specific facility where terminal 10 is located. In a further embodiment, display 30 may also be configured to provide Internet access through terminal 10.

Although the details of every possible icon are not disclosed herein, it should be understood that any type of icon and/or functionality of terminal 10 that is configured to enhance the experience of the user and/or that is configured to replicate human interaction is contemplated within the scope of the present invention. Some of the icons and interactions will be disclosed in more detail, but this specific disclosure should not be interpreted to mean that the icons discussed below are any more or less important than other icons or choices for interaction with terminal 10. Various embodiments of the invention allow a user to interact with terminal 10 whenever the user desires, such that the user is not required to wait to speak with hotel employees, for example, where the user must be placed on hold due to high call volume from other hotel guests. According to still other embodiments, a user may interact with terminal 10 to make the following requests: housekeeping requests, room service requests, wake up requests, weather requests, local information requests, hotel information requests, account information requests, billing requests, special offer requests, survey requests, entertainment requests, games requests, medical requests, message requests, communication requests, email requests, social interaction requests, and check out requests. In still other embodiments, terminal 10 is configured to provide any service that is capable of being provided via a website and/or the Internet.

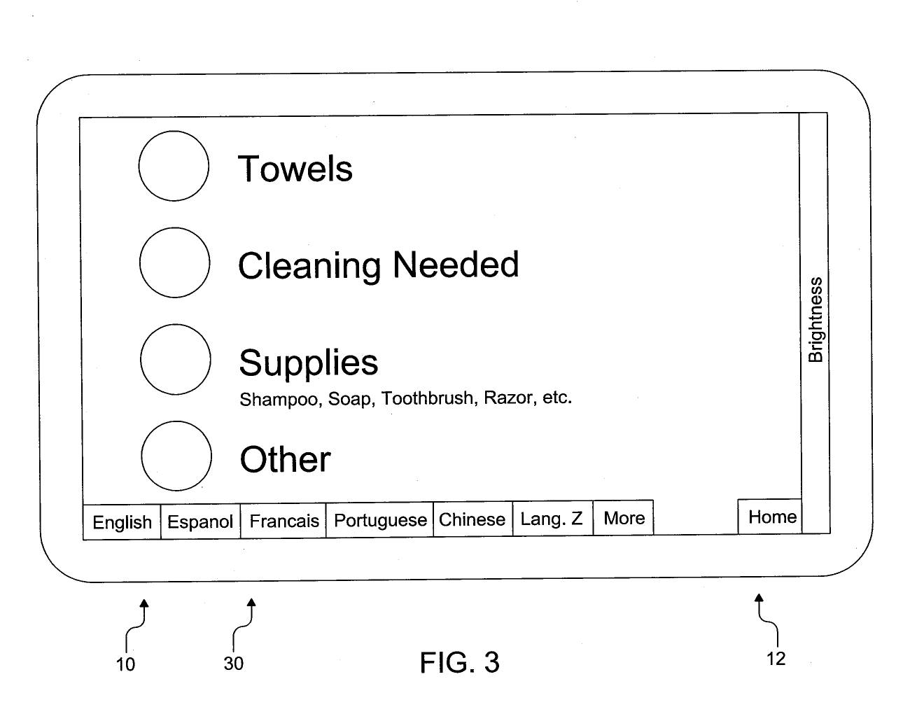

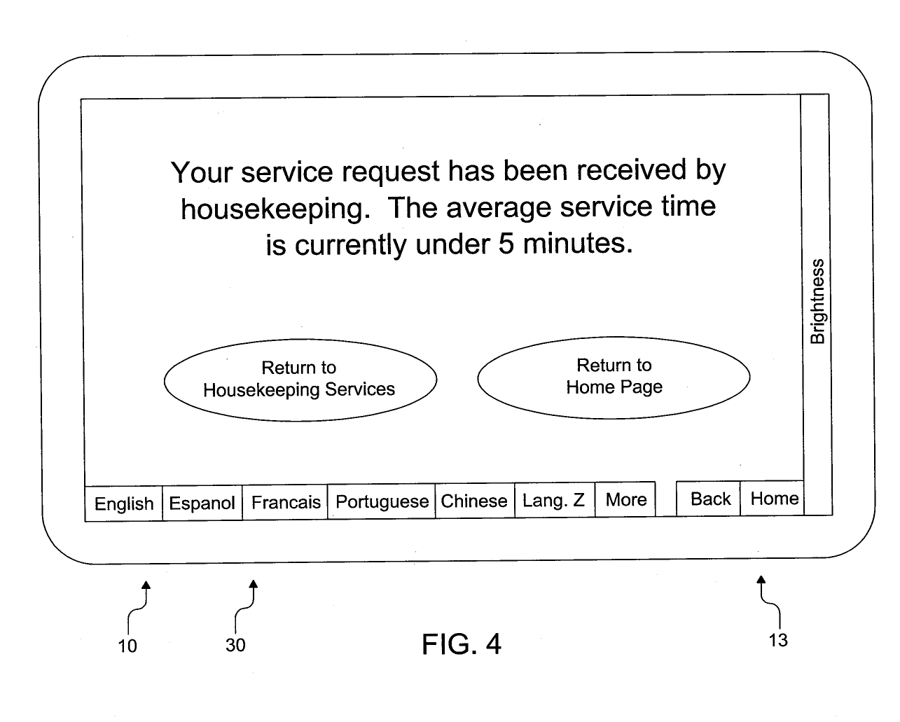

In one embodiment, a housekeeping icon may allow the user to interact with the housekeeping staff of a hotel, for example to make housekeeping requests such as guest service requests for additional towels and toiletries, or requests for additionally cleaning. With reference to FIGS. 3-4, after a user clicks on the housekeeping icon, display 30 may show a housekeeping screen 12. Housekeeping screen 12 may display a number of other icons showing housekeeping options, such as requests for towels, cleaning, supplies, toiletries, and the like. When a user clicks on one of these options, he may be shown a housekeeping processing screen 13. Housekeeping processing screen 13 may show information regarding the processing of the housekeeping request, such as an estimated time for completion of the request.

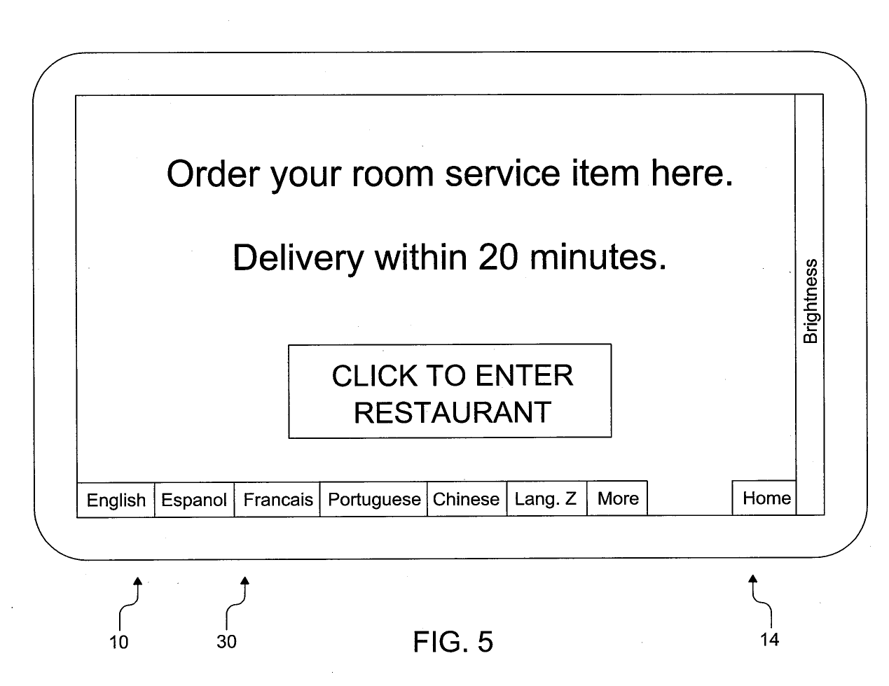

In another embodiment, and with reference to FIG. 5, a room service icon may direct a user to a room service screen 14. Room service screen 14 may provide a menu of available options for room service dining and may allow users the option to pay for the food electronically and request specific delivery times. Room service screen 14 may further include an introductory screen showing the estimated wait time for a room service order, and an option for the user to place an order if the wait time is acceptable.

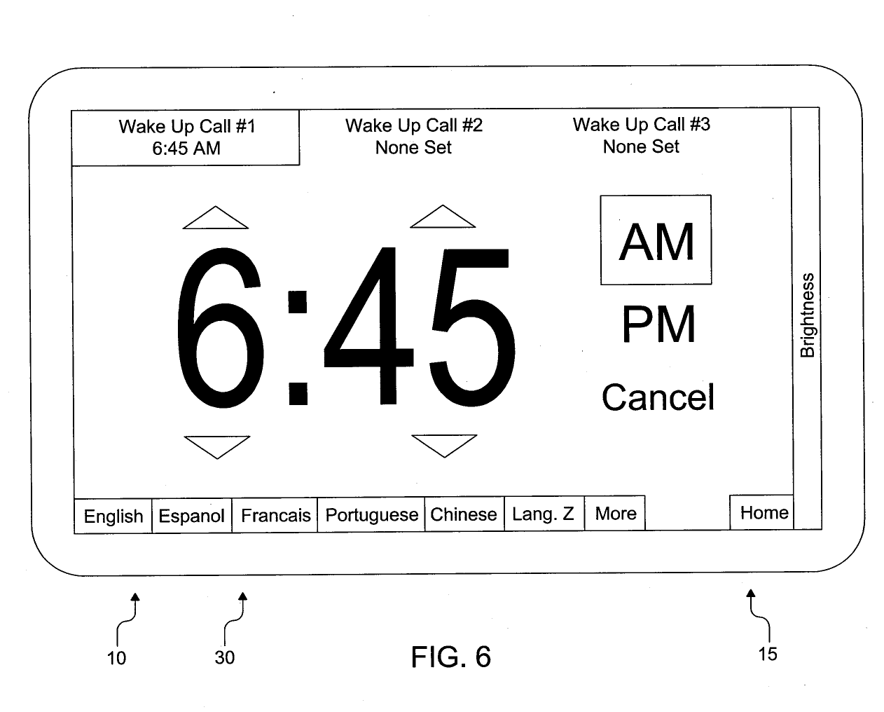

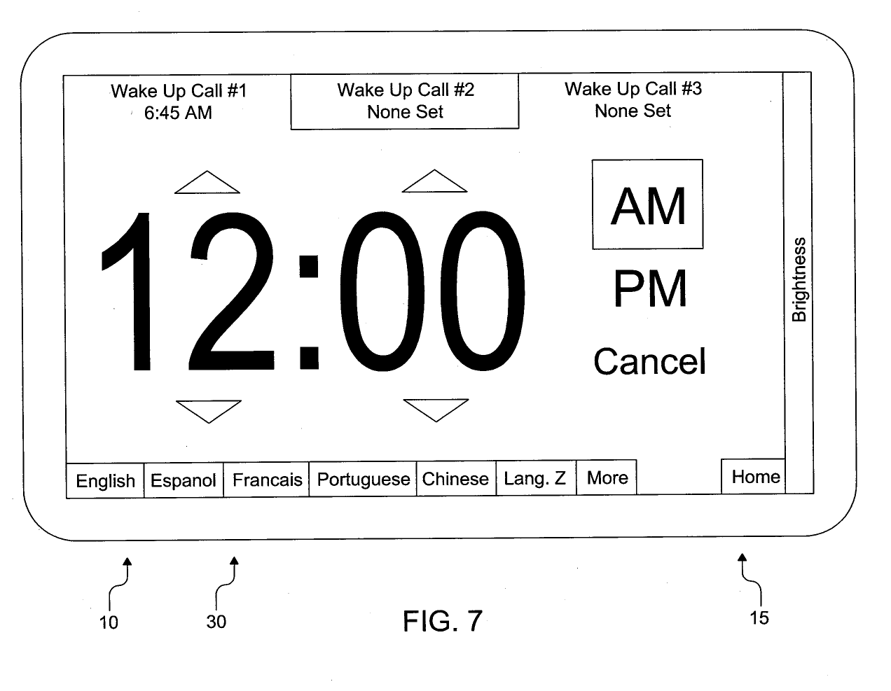

According to yet another embodiment, and with reference to FIGS. 6-7, a wake up call icon may direct a user to a wake up call screen 15 where the user may be allowed to set one or more wake up calls through terminal 10 without needing to place a call to the hotel staff. The user may choose to have the wake up call made through any number of methods, such as the hotel telephone system, through an alarm on terminal 10, and/or to the user's cellular telephone. In still other embodiments, terminal 10 may be configured to display a clock, and in some embodiments, the clock display may be the default and/or sleep screen of terminal 10.

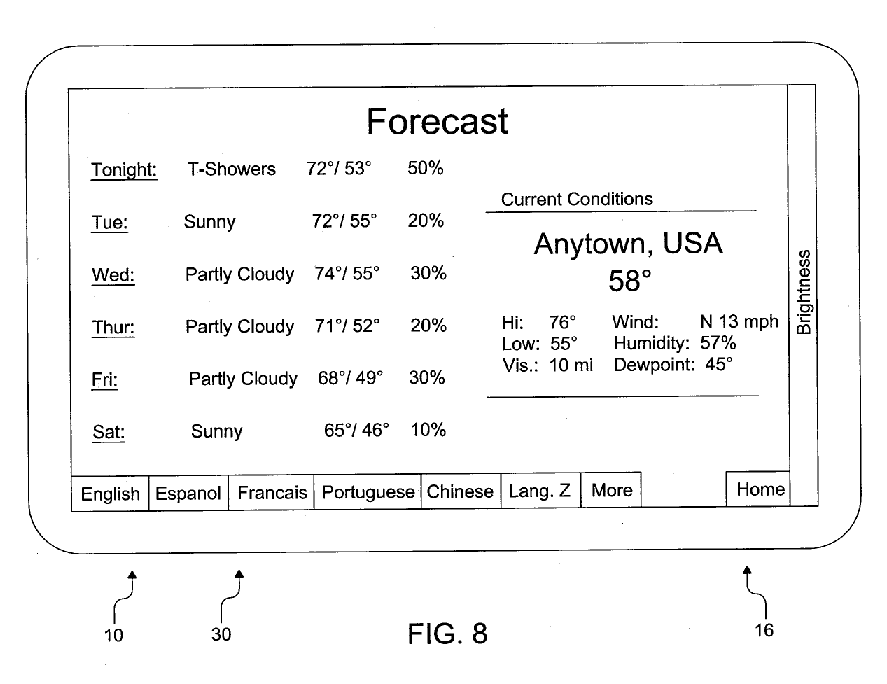

In accordance with a further embodiment, and with reference to FIG. 8, a local weather icon may direct a user to a weather screen 16 on display 30, where the user may be allowed to see current local weather conditions and/or forecasts of local weather conditions. Weather screen 16 may further be configured to allow a user to look at weather from other cities, for example, where the user's next destination is located.

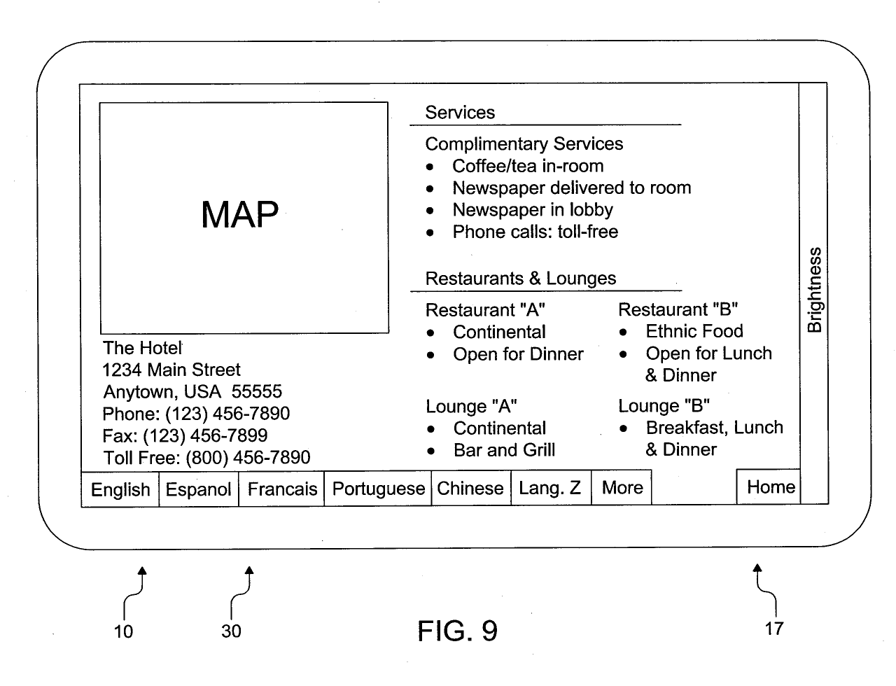

With reference to FIG. 9, other embodiments comprise a hotel information icon that may direct a user to a hotel information screen 17 that may contain any information about the hotel, such as check-out times, hotel amenities such as restaurants, spas, exercise facilities, entertainment facilities, golf courses, and the like. Through this icon the user may find any material that a hotel would maintain in hardcopy form in a folder with hotel information that sits in the guest rooms. Through this icon, the user may also be able to access his hotel bill and check-out from the hotel without needing to wait in line at the front desk. In embodiments where a printer is included with terminal 10, the user may obtain a final copy of his hotel receipt from terminal 10. In some embodiments, a traffic icon may be included as part of hotel information screen 17. In other embodiments, the icon may be part of a different screen. Regardless of where the icon appears, it may direct a user to a screen where the user may see current local traffic and/or typical local traffic conditions for a particular time of day so that the user can plan how much time to allow for trips from the hotel.

In other embodiments of the invention, terminal 10 may comprise a games icon that allows the user to conduct various forms of entertainment via terminal 10. For example, the user may be able to play a number of single-player games such as solitaire. In other embodiments, where terminal 10 is connected to the Internet (as discussed further below), the user may play games against other individuals on the Internet. In still other embodiments, where terminal 10 is connected to a hotel network (as also discussed further below), the user may play games and/or otherwise interact socially with other hotel guests.

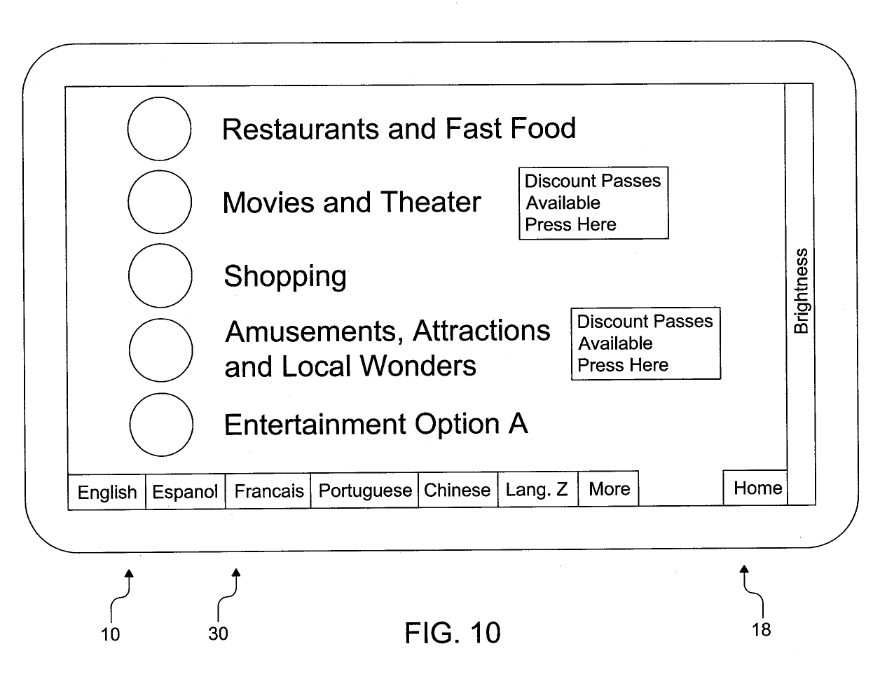

According to further embodiments, and as will be discussed below, terminal 10 may have access to information specific to the user, where the information may be based on previous choices by the user, preferences established by the user, and/or aggregated data based on choices made by other users having certain characteristics. For example, a local entertainment icon (such as the “Local Food, Shows and Fun” icon depicted in FIG. 2) may provide a menu of local restaurants, clubs, attractions, current events, and the like. The icon may further provide suggested entertainment options for the specific user, for example, based on user likes, dislikes, preferences, previous choices, and/or based on other factors configured to customize the options to the particular user. The user may submit an entertainment request via terminal 10, and the entertainment request may be automatically sent to an entertainment provider associated with the request. For example, with respect to FIG. 10, an entertainment icon may direct a user to an entertainment screen 18 where the user may be presented with various entertainment choices related to information specific to the user, information specific to the hotel, and/or information specific to various sets of data and/or users, including those discussed above.

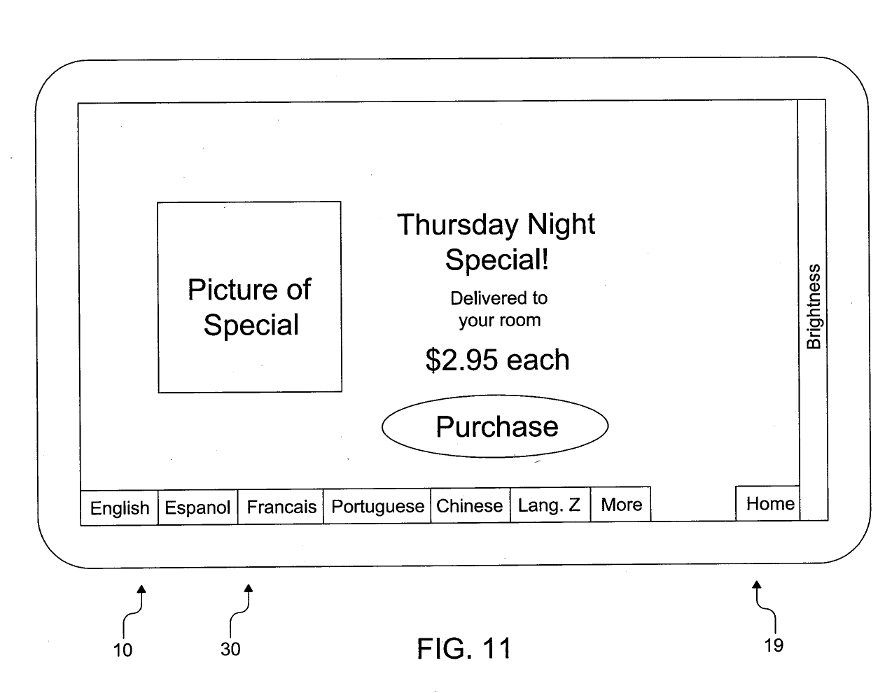

In other embodiments, and with reference to FIG. 11, a special offers icon may direct a user to a special offers screen 19 that may provide customized offers to the user based on the above-listed and other factors. The special offers may be related to entertainment, or they may relate to any type of transaction that the user may complete while staying at the hotel. In certain embodiments, terminal 10 may be configured to remind a user of a significant event, such as a birthday or anniversary, for which the user may need to purchase a gift, and terminal 10 may provide a special offer related to a suggested gift for the significant event. The offers may be associated with a plurality of businesses and entities, such as businesses near or remote from a hotel in which a user is staying, hotels, airlines, Internet businesses, and the like. For example, the offer illustrated in FIG. 11 may be tailored to a user's preference, such as a favorite dessert.

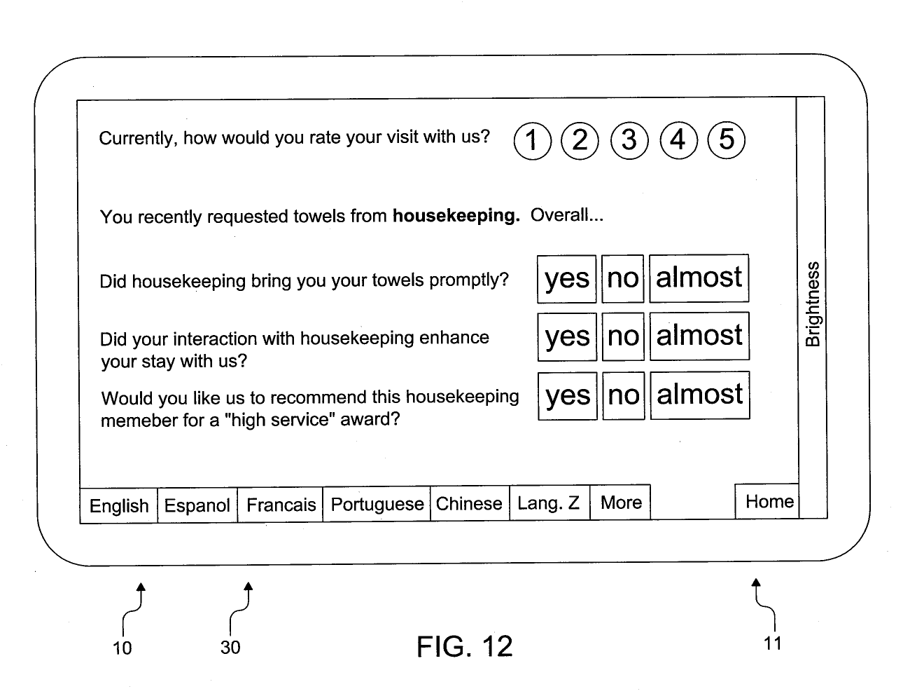

In still other embodiments, and with reference to FIG. 12, a survey icon may direct a user to a survey screen 11 that may allow a user to provide feedback to the facility where terminal 10 is located. Participation in the survey may be voluntary or a condition for receiving certain benefits at the facility. For example, participating in the survey may allow a user to have access to special offers, discounts, or incentives that the user would not otherwise have without participating in the survey. As illustrated in FIG. 12, survey screen 11 may comprise various selections and or criteria such as an overall rating of an experience, a rating of the response to a housekeeping service request, and other ratings of specific experiences of a particular user and/or experiences applicable to a number of users.

It should be understood that the types of information and/or services available through terminal 10 are virtually unlimited. For example, terminal 10 may provide social networking within the facility where terminal 10 is located, or across a number of facilities of the same type as the facility where terminal 10 is located (e.g., across the same brand of hotel). Terminal 10 may further provide television guides, television programming, radio guides, radio stations, Internet radio (e.g., Yahoo and other feeds), news, pay-per-view movies, diet information, fitness information, medical information such as local medical, dental and other health providers, dry cleaners, taxi services, local news, local events, national news, regional news from a facility user's home town, other transportation services, access to other sources of information such as the Internet, and various other products, information, and services. In other embodiments, terminal 10 may be configured to show safety information, such as crime ratings and safer zones in particular areas surrounding the facility where the terminal is located. In still other embodiments, Terminal 10 may be configured to provide various types of information, such as medical information; dental information; information relating to stores such as retail, drug, clothing, department, specialty and convenience stores; information relating to entertainment, movies, dancing, night clubs, bars, restaurants, sports grills and bars, amusement parks, malls, spas, local events, legal services, business services, golf, fitness centers, television (such as a television guide), sporting events (including professional & college), tailors, electronics, software; information relating to food, such as relating to national chains, local chains, regional brands, local favorites, hidden gems (such as little-known places that are rated highly by other users); and information relating to modes of transportation such as taxis, trains, busses, limos, subways and shuttles. As with other interaction options, these options may be tailored specifically to the user accessing terminal 10. For example, in certain embodiments, certain icons on terminal 10 may be made larger and/or may appear bolder than other icons in response to aggregated data based on a user's prior selections and/or on other users choices that have similar characteristics to another terminal user. In still other embodiments, certain icons and/or choices displayed on terminal 10 may be moved to a more prominent location, such as at the top of a list, as a result of the aggregated data.

With reference back to FIG. 2, terminal 10 may further comprise options for facilitating user customization of terminal 10. Various options may be configured to be displayed on any every screen displayed on display 30 to facilitate easy user access to these options. For example, terminal 10 may provide access to the user's account associated with use of terminal 10 where the user may log-in, change preferences, access a facility bill, set privacy options, set display options such as color and brightness (including turning the display off completely), and set other options. Terminal 10 may further provide the user access to various types of messages, such as email at a local hotel email address or any email address that the user may access via the Internet, hotel messages, instant messages, text messages, messages specific to the terminal network that will be discussed below, and any other type of message that may be conveyed via display 30. In other embodiments, terminal 10 may function as a speaker phone, and a user may select an option that enables the speaker phone functionality. In certain embodiments, the terminal speaker phone may replace the standard hotel room telephone, and the user may interact with hotel staff and place other calls via the speaker phone in terminal 10. In still other embodiments, a keyboard overlay option may display a graphical keyboard on display 30 such that the user may interact with terminal 10.

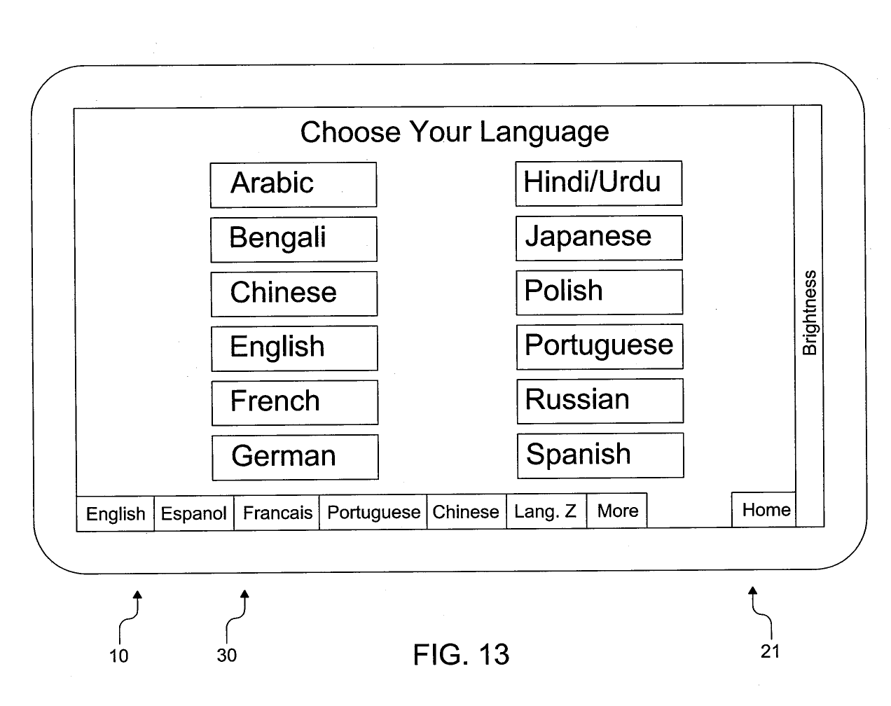

In certain embodiments, and with reference to FIG. 13, a user may be able to choose a specific language in which to interact with terminal 10. For example, terminal 10 may provide information in a number of languages, including without limitation, Arabic, Bengali, Chinese, English, French, German, Hindi/Urdu, Japanese, Polish, Portuguese, Russian, Spanish, and other languages. The different languages may be selectable from a language screen 21. The different languages may be represented by flags associated with the different languages to facilitate the selection of a language. In some embodiments, as illustrated for example on FIG. 13, a subset of the available languages may be available on most screens of display 30 in order to facilitate easier switching between languages.

According to further embodiments of the invention, terminal 10 may be configured to display advertising. The advertising may be targeted to a specific user, the advertising may be general to the facility where terminal 10 is located, and/or the advertising may be based on any consideration advertisers may take into account. Part of the revenue for the facility (where terminal 10 is located) and the operator of the network (of which terminal 10 is a part) may be the advertising revenue associated with these advertisements. Advertisers may pay for the advertisements based on any advertising revenue model now known or developed in the future, such as pay-per-display, pay-per-click, display time, and the like. The advertising content may be dynamically displayed based on time of day, duration, response rate, advertising rate, and/or other criteria. Various advertising options may be available to advertisers, such as branding through impressions, call to action (e.g., push to telephone or otherwise communicate with the advertiser), electronic commerce, subscription advertising, and/or other options. Advertising may be displayed as banner advertisements as illustrated in FIG. 2, or may be text, image, video, audio and/or any other type of advertisement.

When a user clicks on or otherwise chooses an advertisement, the user may be taken to an advertiser's Internet website, an advertiser's display screen maintained on the terminal system's servers, or the user may be connected via telephone and/or video conference with the advertiser. For example, where the advertisement is for a pizza restaurant, the user may place an order for pizza delivery to the user's hotel room through terminal 10 with or without human interaction with someone at the pizza restaurant.

In accordance with various embodiments of the electronic concierge system, various terminals may be located in different parts of a facility. For example a terminal 10 may be located in each hotel room in a hotel facility, and a terminal 10 may also be located in common areas of the hotel. Each terminal is configured to communicate with at least one hotel server or a centrally-located server not on the hotel premises. The hotel server may provide updates and/or server information to the terminals, pass communications to/from the terminals from/to the appropriate entities and/or individuals, allow communication between the different terminals, aggregate user data from the terminals, and the like. In various embodiments, server information communicated to terminal 10 may comprise at least one of housekeeping information, wake up information, room service information, weather information, hotel information, special offers information, survey information, entertainment information, guest information, guest account information, messages information, email information, Internet information, language information, telephone information, and games information. Any communication to or from the terminals may be encrypted and/or secured in any manner now known or that is developed in the future in order to maintain the privacy of the user and the security of the data and/or information transmitted.

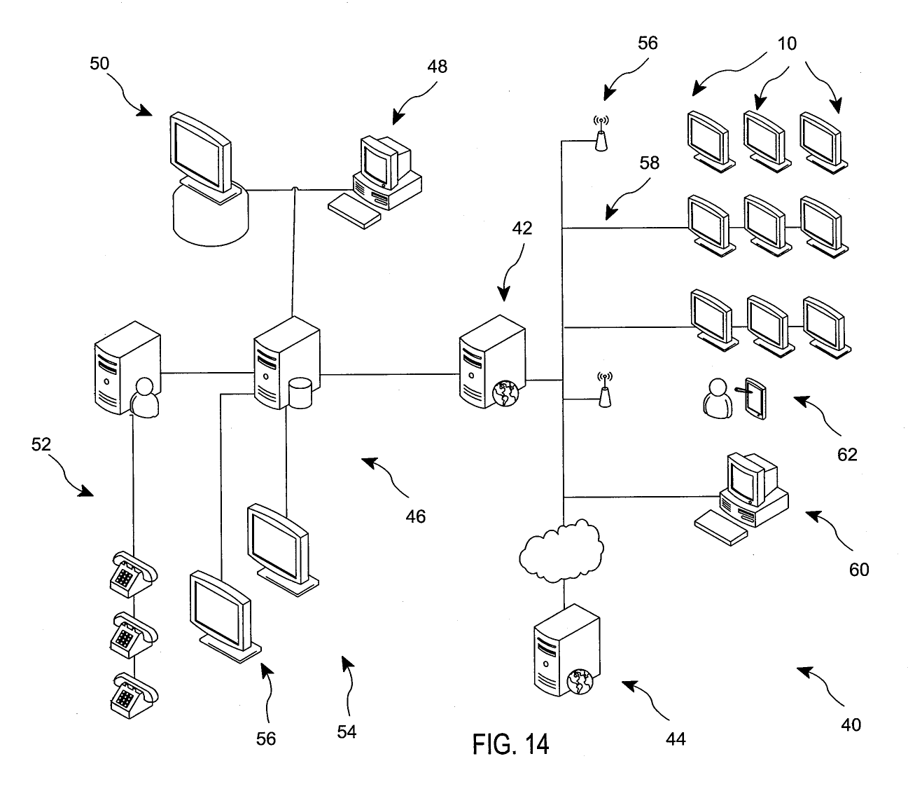

One example of a terminal network 40 is illustrated in FIG. 14. Terminal network 40 may comprise a plurality of terminals 10 configured to communicate with a facility server 42. Facility server 42 may be located at the facility or may be an offsite server. Facility server 42 may be configured to communicate with a data and maintenance server 44 associated with an entity that operates a plurality of terminals at a plurality of facilities. For example, a terminal network manager may sell and/or lease terminals to a number of different hotel chains and may maintain and manage data associated with the users of all the terminals so that the hotel does not need to do so. Broadening the management of data across a number of hotel chains facilitates more effective assessment of the needs of individual terminal users at a given hotel. In another embodiment, data and maintenance server 44 may be operated by a single facility and/or by a facility chain over a number of facilities managed by the facility chain. Facility server may further be configured to communicate with an existing facility management server and/or system 46 that comprises components such as reservation system 48, self-serve system 50, telephone system 52, restaurant system 54, guest management system 56 and other facility system and service components.

For the sake of brevity, conventional data networking, and other functional aspects of the systems (and components of the individual operating components of the systems) may not be described in detail herein. Furthermore, the connecting lines shown in the various figures contained herein are intended to represent exemplary functional relationships and/or physical and/or non-physical (e.g., wireless) couplings between the various elements. It should be noted that many alternative or additional functional relationships or physical connections may be present in a practical electronic transaction system.

Communication between the various terminals, servers, and systems according to embodiments of the present invention is accomplished through any suitable communication means, such as, for example, a telephone network, Intranet, Internet, point of interaction device (point of sale device, personal digital assistant, cellular phone, kiosk, etc.), online communications, off-line communications, wireless communications, radio frequency communications and/or the like. One skilled in the art will also appreciate that, for security reasons, any servers, databases, systems, or components of the present invention may consist of any combination of servers, databases or components at a single location or at multiple locations, wherein each server, database or system includes any of various suitable security features, such as firewalls, access codes, encryption, de-encryption, compression, decompression, and/or the like.

In an embodiment as illustrated in FIG. 14, terminals 10 may communicate with local server 42 via wireless connections 56 and/or wired connections 58. Wireless connections 56 may comprise radio frequency connections, Bluetooth connections, and the like. Wired connections 58 may comprise telephone connections, coaxial connections, cable connections, and the like. Wireless connections 56 and wired connections 58 may facilitate communication over Intranet, Internet, Ethernet, telephone, cellular, satellite, cable and/or other types of communications networks.

According to further embodiments of the invention, local server 42 may be configured to communicate with a local management terminal 60 configured to allow the facility owner to customize and/or configure terminal network 40 according to the needs of the particular facility. In certain embodiments, local management terminal 60 may comprise any of terminals 10, where any of terminals 10 may allow a facility manager to log-in and customize terminal network 40. In other embodiments, a dedicated local management terminal 60 may be used to customize terminal network 40. Customization of terminal network 40 may comprise modification of any of the information that is available to users through terminal 10 as disclosed herein, or any other modification of any other information that a facility would want to provide to a terminal user. Where the facility wishes data and maintenance server 44 to aggregate data based on customized information, and where data and maintenance server 44 is managed by an entity other than the facility, the facility may need to comply with certain requirements in order to facilitate the collection and aggregation of a particular type of data.

In accordance with other embodiments of the invention, local server 42 may be configured to communicate with facility staff and/or guest service providers via at least one staff terminal 62. Staff terminal 62 may comprise a dedicated terminal located in certain parts of the facility, for example at the concierge desk, housekeeping office or the hotel restaurant. In other embodiments, staff terminal 62 may comprise a hand-held or portable device that is carried by mobile staff such as housekeeping or maintenance staff. When staff terminal 62 carried by a mobile staff member receives a request from a terminal 10, the appropriate staff member may be directed to carry out a request from the user of terminal 10. For example, staff terminals 62 may comprise global positioning satellite (GPS) technology or other location determining technology (such as wireless triangulation) such that local server 42 is able to assign a request to a staff terminal 62 that is closest to the location of the terminal 10 from which a request emanated. In other embodiments, local server 42 may choose the staff member that is most capable of performing certain maintenance tasks to respond to a particular terminal user's request.

Although one embodiment of a terminal network has been disclosed herein and illustrated in FIG. 14, it should be understood that many types of network configurations may be operable in connection with a plurality of terminals 10, and the disclosure herein should not limit the invention to any particular network configuration.

Because information associated with users of the terminals will be aggregated by a server in order to provide customized information to users of the terminals, it may be necessary for users to pre-register for use of the terminals in order to comply with various privacy and/or consumer laws. For example, users be asked to register in order to track preferences and personalize the experience of the user. When a user registers, he may be required to consent to the way information will be collected from him, who may be able to access the information, and the ways in which the information may be used in the future. Upon registration, the user may be assigned a user-identifier, such as an account code, log-in name, user name, and the like. The user-identifier may facilitate the personalization of the user's experience at whichever terminal the user is using.

According to further embodiments of the invention, data from terminals 10 may be aggregated and/or used in a variety of different ways. For example, data may be maintained and aggregated for each individual user. Each time a user makes a choice from the terminal, that choice may be stored and aggregated to serve as a basis for recommendations tailored to the particular user. In other embodiments, all the choices of users at a particular facility may be stored an aggregated to serve as a basis for recommendations tailored to all users of a particular facility. In still other embodiments, data may be aggregated based on the location of the facility such as a city where a facility is located, the type of facility such as a hotel or hospital, the owner of the facility such as a hotel chain owner, the gender of the user, the nationality of the user, the age of the user, a particular loyalty program to which a user belongs, a plurality of loyalty programs, and/or various other characteristics of the facility or a particular user or group of users. For example, aggregated data stored on local server 42 and/or data and maintenance server 44 may be related to at least one of: a guest characteristic, a previous guest selection, a specified guest preference, a guest entertainment choice, a guest entertainment preference, a housekeeping request, a wake up request, a room service request, a restaurant option, a show option, an electronic games option, a movie option, a club option, a local entertainment option, weather information, hotel information, news information, health information, diet information, medical information, transportation information, personal services information, social interaction information, entertainment information, golf information and television information. All of these aggregation possibilities and any other data aggregation technique or protocol are configured to provide a customized and/or enhanced experience for a user of terminal 10.

For example, with reference to the traveler's situation discussed in the background section above, a guest that has pre-registered with terminal network 40 may first enter a hotel room and see a personalized greeting on display 20. The personalized greeting may present certain personalized options that the guest may desire upon first entering a hotel room. The personalized greeting and/or option may be based on any of the types of aggregated data disclosed herein.

If the guest is looking for something to eat, he may choose the option on the display that would provide dining options. Upon the guest's selection of that option, the terminal may request personalized dining options from local server 42 which may request information from data and maintenance server 44 or which may have the information already stored on local server 42. Display 20 will then provide the personalized dining options which may include favorite restaurants or favorite types of restaurants specified or chosen previously by the guest that are near the hotel, or it may provide suggestions for restaurants based on choices made by other guests of the same hotel. Such suggestions may also be based on user ratings of the various restaurants. In certain embodiments, it may be possible to place an order for dine-in, carry-out, and/or delivery from a desired restaurant through terminal 10, or it may be possible to reserve a table at the desired restaurant. For our traveler above, because he had previously specified his favorite restaurant as such with terminal network 40, terminal 10 may have presented this option to him and he could have visited the restaurant or ordered food via the restaurant's delivery service.

According to further embodiments, terminal network 40 may provide means for the terminal users to seek social interactions with other terminal users in the same facility. In other embodiments, the user may seek social interactions with anyone throughout the world at a facility where a terminal 10 on terminal network 40 is located. Similar to our traveler above, it is possible that other guests may desire social interaction with people staying in the same hotel. Our traveler above may have chosen, upon registration with terminal network 40, to make certain of his interests available to other terminal users. If he had done so, it may have been possible for other terminal users at the hotel to search for users with common interests and send an instant message, text message, or other communication to the traveler. Of course terminal network 40 may be configured to take into account security measures and protocols in order to prevent interactions that may be dangerous or undesired. For example, the message could specify a public meeting place at the hotel if the traveler decides to accept the invitation for social interaction. In other embodiments, terminal 10 may facilitate social functionality such as chatting, profile matching, favorite friends, locations of contacts, games, networking, and the like.

In other embodiments, a user may choose to synchronize his calendar or certain aspects of his calendar with terminal network 40. For example, a user may choose to provide important dates, such as birthdays and anniversaries, to terminal network 40. If a registered user is staying in a hotel where terminal 10 is present, terminal 10 may provide reminders for these important dates. Terminal 10 may further provide advertising and gift offers and suggestions for these important dates. Our traveler may have remembered to purchase a gift for his daughter's birthday had he been using a terminal network according to embodiments of the present invention.

According to still other embodiments of the invention, advertising may be provided to terminal 10 based on prior choices and/or activities of a user associated with a particular terminal. For example, targeted advertising may be based on specific dining or entertainment choices made by a user on a previous occasion, or the advertising may be based on information provided by a user during the registration process. Advertising may also generally be provided according to the location of terminal network 40 and/or generalized information relating to various classes of users.

Terminal 10 may further be configured to provide discount offers targeted to facility users. For example, certain businesses surrounding a hotel may provide discounts to people staying at the hotel. Terminal 10 may provide these discount offers to users in order to make the users aware of the offers. Businesses making the offers may pay advertising revenue to terminal network 40 and/or the facility owner in order to provide these offers to facility users.

In another embodiment, a facility owner may desire survey information from guests at the facility. Many guests, such as hotel guests, may not take the time to provide such a survey. However, terminal 10 may be configured to condition certain functionality of terminal 10 on the guest's submission of a survey. In other embodiments, terminal 10 may provide certain offers in response to a guest's survey that are not available if the guest does not complete the survey.

In a further embodiment, convention and/or meeting planners may utilize terminal 10 to schedule aspects of a convention and/or meeting. For example, the meeting organizer can provide the meeting schedule to the facility such that the schedule will be available on the terminals in the rooms of the meeting attendees. Terminal 10 may be further configured to allow the attendees to choose which aspects of the meeting or convention they want to attend. In other embodiments, terminal 10 may be configured to only display entertainment options to attendees that are available during times that are not during the convention or meeting activities. The meeting or convention organizer would further be able to submit messages to all attendees through the individual terminals in the attendees' rooms.

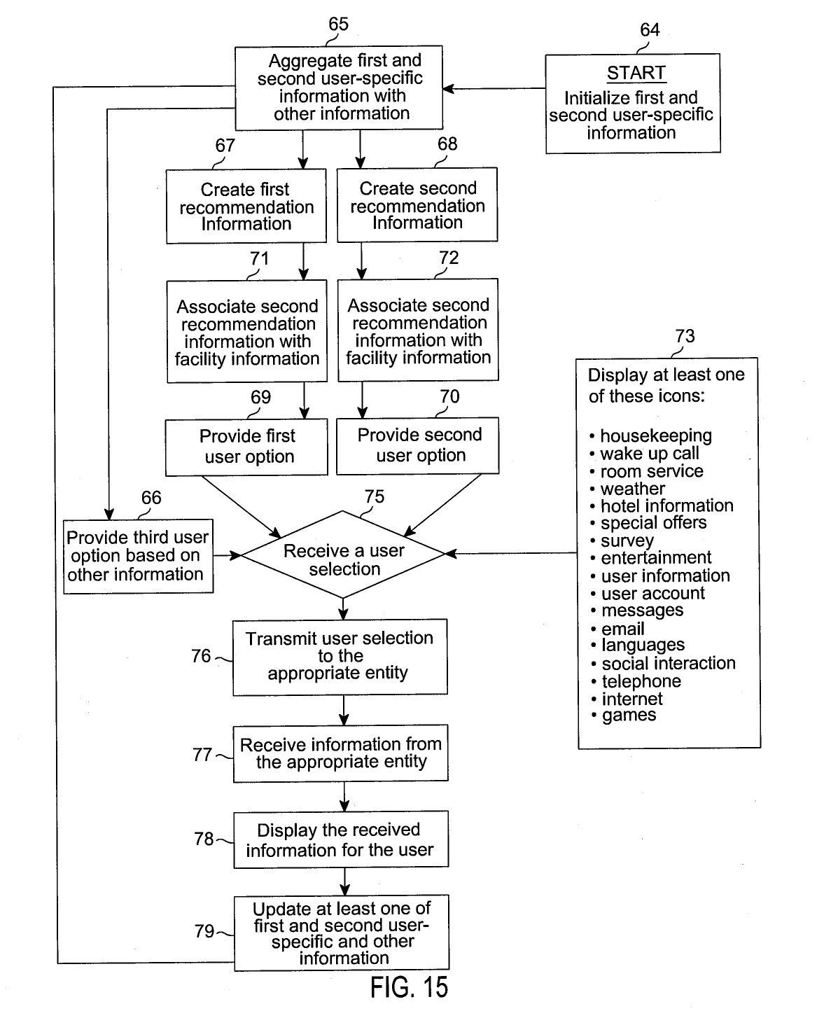

A method of operating the electronic concierge system according to one example embodiment of the present invention will now be discussed with reference to FIG. 15. Initially, at 64, information for the system needs to be initialized. Initialization 64 may occur when a user registers for the system. For example, a user may specify different types of information, such as entertainment preferences, restaurant preferences, hotel preferences, travel preferences and the like. In other embodiments, the system may be initialized with aggregated data from multiple users as discussed above. Once the system is initialized, various information is stored by the system, for example, first, second and third types and/or values of information may be stored at 65. For example, information specific to a first user may be stored, information specific to a second user may be stored, and aggregated information based on a plurality of users and/or facilities may be stored. It should be noted that data specific to more than two users may be stored, but these types of data are used for means of illustration of this example embodiment.

After initialization 64 and storing 65, the system may process the information at 67, 68, 71, and 72. Processing may comprise any type of operation that is conducted using the information. For example, the system may create first recommendation information associated with the first user and second recommendation information associated with the second user. The recommendation information may then be associated with information related to the facility. The facility information may be related to services and/or products available inside or outside of the facility. For example, facility information may be related to advertising, entertainment, and/or other information disclosed herein or any other information that may be desirable to display on terminal 10. Based at least in part on the recommendation information and the facility information, a first user option and a second user option may be provided to the first user and the second user at 69 and 70. The first and second user options may be provided on different user terminals. In other embodiments, for example when the user option is provided in a common area of the facility, both user options may be provided on the same terminal. In still other embodiments, a third user option may be provided at 66 to a third user of the facility, where the third user option is based at least in part on the information aggregated at 65.

The displaying of the different options may be dependent on a user selection, or they may automatically be displayed. For example, where a user clicks on an entertainment icon on display 30, an appropriate entertainment option may be displayed. With respect to advertising, an appropriate advertising based on the information may be automatically displayed. In further embodiments, a plurality of icons may be displayed in order to give the user further options to enhance his experience. Examples of such icons that may be displayed at 73 are a housekeeping icon, a wake up call icon, a room service icon, a weather icon, a hotel information icon, a special offers icon, a survey icon, an entertainment icon, a guest information icon, a guest account icon, a messages icon, an email icon, a languages icon, a social interaction icon, a telephone icon, an Internet icon, and a games icon.

When options are displayed at 66, 69, 70, and/or 73, the user may make a selection based on the displayed information. When a user selection is received at 75, the selection is routed to the appropriate entity at 76. For example, a request based on advertising may direct the user to an Internet website for the entity who sponsored the advertisement. In other embodiments, the advertisement may direct the user to an ordering system relating to the advertisement. Similarly, a user request based on an entertainment option or a user offer may route the user via display 30 to the entity that may address the user's request. The system may receive information relating to the request from the appropriate entity at 77, and the user then may receive the information via display 30 at 78. It should be noted that although 78 depicts one box, the information displayed at 78 may be through a single terminal and/or multiple terminals depending on the user for which the information is intended. Based on the user's selection, the information stored on the system may be updated at 79, and the entire system information may be updated at 65. For example, the system may note a further preference of a user and may apply the preference to further information provided to the user. In other embodiments, the system may use the user's request to update the other information and/or to provide targeted information to other guests at the same facility.

It should be understood that only some examples of the ways in which terminal 10 and terminal network 40 may enhance the experience of users of terminal network 40. Terminal network 40 may be configured in many ways other than what has been disclosed herein. For example, different data aggregation techniques may be used without departing from the scope of the present invention. Furthermore, different personalization options and available choices may be provided to a user depending on the type of facility where terminal network 40 is located. Such modifications are within the scope of the present invention.

It should further be understood that various computing devices have been disclosed herein, and other computing devices may be utilized without departing from the scope of the present invention. For example, the computer of terminal 10, or computers associated with any aspect of the present invention may comprise a number of components. For example, the computer may comprise at least one of the following: a processor such as a microprocessor, a type of memory, a data storage device, an operating system, a video card, a universal serial bus (USB) port, an audio port, a peripheral port, and combinations thereof. In other embodiments, other components of computing devices that are now known or developed in the future may be used as part of the computer of terminal 10 without departing from the scope of the present invention.

In various embodiments of the invention, the computer of terminal 10, and/or any other computing device or system disclosed herein, may include a processor for processing digital data, a memory coupled to the processor for storing digital data, an input digitizer coupled to the processor for inputting digital data, an application program stored in the memory and accessible by the processor for directing processing of digital data by the processor, a display such as display 20 coupled to the processor and memory for displaying information derived from digital data processed by the processor and at least one database, wherein the database may include various types of data, including user data, aggregated user data, facility data, merchant data, advertising data, entertainment data, medical data, financial data and/or like data that could be used in association with the present invention. As those skilled in the art will appreciate, the computer of terminal 10 will typically include an operating system (e.g., Windows NT, 95/98/2000/XP/Vista, Linux, Solaris, Unix, etc.) as well as various conventional support software and drivers typically associated with computers.

According to various embodiments, databases that may be utilized by the present invention may be any type of database, such as relational, hierarchical, and/or the like. Common database products that may be used to implement the databases include any of the database products available from IBM (White Plains, N.Y.), such as Informix or DB2, from Oracle Corporation (Redwood Shores, Calif.), from Microsoft Corporation (Redmond, Wash.), such as Microsoft Access, MSSQL, MySQL, or SQL Server, or any other database product produced by any entity. The databases may be organized in any suitable manner, including as data tables or lookup tables. Association of certain data may be accomplished through any data association technique known and practiced in the art. For example, the association may be accomplished either manually or automatically. Automatic association techniques may include, for example, a database search, a database merge, GREP, AGREP, SQL, and/or the like. Additionally, components such as Access or SQL Server, Oracle, Sybase, Informix MySQL, Intervase, etc., may be used to provide an ADO-compliant database management system.

According to further embodiments of the invention, the various computing devices disclosed herein may comprise certain industry standards. For example, the computing devices may comprise system management standards such as Remote Management Agent, Light Path Management, Wired for Management, Wake on LAN, SMBIOS and PXE. In other embodiments the computing systems may comprise power management standards such as APM 1.2 configured to be used with the Linux operating system.

Computers associated with terminal 10 and/or terminal network 40 may provide a suitable website or other Internet-based graphical user interface which is accessible by users. In one embodiment, the Internet Information Server, Microsoft Transaction Server, and Microsoft SQL Server, are used in conjunction with the Microsoft operating system, Microsoft NT web server software, a Microsoft SQL database system, and a Microsoft Commerce Server. The term “website” as it is used herein is not meant to limit the type of documents and applications that might be used to interact with the user. For example, a typical website might include, in addition to standard HTML documents, various forms, Java applets, Javascript, active server pages (ASP), common gateway interface scripts (CGI), extensible markup language (XML), dynamic HTML, cascading style sheets (CSS), helper applications, plug-ins, and the like.

The present invention may be described herein in terms of functional block components, screen shots, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PHP, Python, PERL, Visual Basic, SQL Stored Procedures, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention could be used to detect or prevent security issues with a client-side scripting language, such as JavaScript, VBScript or the like.

With respect to terminal network 40, it should be appreciated that many applications of the present invention could be formulated. One skilled in the art will appreciate that the network may include any system for exchanging data or transacting business, such as the Internet, an intranet, an extranet, WAN, LAN, satellite communications, and/or the like. It is noted that the network may be implemented as other types of networks, such as an interactive television (ITV) network. The users may interact with the system via any input device such as a keyboard, mouse, kiosk, personal digital assistant, handheld computer (e.g., Palm Pilot®), cellular phone and/or the like. Similarly, the invention could be used in conjunction with any type of personal computer, network computer, workstation, minicomputer, mainframe, or the like running any operating system such as any version of Windows, Windows Vista, Windows XP, Windows NT, Windows2000, Windows 98, Windows 95, MacOS, OS/2, BeOS, Linux, UNIX, Solaris or the like. It should be readily understood that the invention may be implemented using TCP/IP, IPX, Appletalk, IP-6, NetBIOS, OSI or any number of existing or future communications protocols.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, solid-state storage devices, flash memory devices, optical storage devices, magnetic storage devices, and/or the like.

The present invention may be described herein with reference to screen shots, block diagrams and illustrations of methods, and apparatuses (e.g., systems), according to various aspects of the invention. It will be understood that the methods disclosed herein may be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory and/or medium that can direct a computer or other programmable data processing apparatus to function in a particular manner, such that the instructions stored in the computer-readable memory produce an article of manufacture including instruction means which implement the function specified in the method. Examples of computer-readable media may be tangible devices such as flash memory, solid state memory, hard disks, optical disks, compact disks, digital video disks, blue ray disks, magnetic storage devices, and the like. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, the methods and illustrations support combinations of means for performing the specified functions, combinations of steps for performing the specified functions, and program instruction means for performing the specified functions. It will also be understood that each step of the methods disclosed may be implemented by either special purpose hardware-based computer systems which perform the specified functions or steps, or suitable combinations of special purpose hardware and computer instructions.

When “at least one of A, B, and C” is used in the claims, unless otherwise noted, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the invention. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

It should be understood that various principles of the invention have been described in illustrative embodiments. However, many combinations and modifications of the above-described formulation, proportions, elements, materials, and components used in the practice of the invention, in addition to those not specifically described, may be varied and particularly adapted to specific environments and operating requirements without departing from those principles. Other variations and modifications of the present invention will be apparent to those of ordinary skill in the art, and it is the intent that such variations and modifications be covered by this disclosure.

1. A method of enhancing a stay of a first user at a facility, comprising:
aggregating first user-specific information and other information to create recommendation information;
associating the recommendation information with facility information; and
providing a first user option in response to associating the recommendation information with the facility information to enhance the stay of the first user at the facility.

2. The method of claim 1, further comprising:
receiving a first user selection in response to providing the first user option; and
updating the first user-specific information in response to receiving the first user selection.

3. The method of claim 2, further comprising:
updating the other information in response to receiving the first user selection;
aggregating second user-specific information and the other information to create second recommendation information;
associating the second recommendation information with second facility information;
providing a second user option to a second user in response to associating the second recommendation information with the second facility information to enhance the stay of the second user at a second facility;
receiving a second user selection in response to providing the second user option;
updating the second user-specific information in response to receiving the second user selection; and
updating the other information in response to receiving the second user selection.

4. The method of claim 2, wherein the first facility and the second facility are at least one of the same facility and a different facility.

5. The method of claim 3, further comprising:
making a recommendation to a third user based at least in part on at least one of the first user selection and the second user selection; and
making a recommendation to a fourth user based at least in part on the other information.

6. The method of claim 3, wherein the other information comprises information not associated with either the first user or the second user, and wherein the other information comprises information accumulated from a plurality of users, wherein the plurality of users is associated with at least one of a plurality of facilities, an individual facility, a plurality of geographical locations, an individual geographical location, a plurality of types of facilities, an individual type of facility, a plurality of loyalty networks, and an individual loyalty network.

7. The method of claim 3, wherein the first user-specific information and the second user-specific information comprise at least one of a user-defined preference, a previous user selection, a user calendar entry, a user contact entry, a user address book entry, a user language, a user country, a user state, a user city, a user school, and a user sports team.

8. The method of claim 3, wherein the first user option and the second user option comprise at least one of an advertisement, a service option, a user offer, an entertainment option, a social interaction option, a message option and an activity option, wherein the message option comprises an option to display a message comprising at least one of an instant message, a voicemail message, a text message, a message from a third user, and a group message, and wherein the user offer comprises an offer from at least one of a local business, a remote business, a hotel, an airline, and an Internet business.

9. The method of claim 3, further comprising transmitting a user request, received through a user terminal, to a facility service provider, wherein providing the first user option comprises displaying the first user option on a first user terminal, and wherein providing the second user option comprises displaying the second user options on a second user terminal.

10. The method of claim 9, wherein the user request comprises at least one of an entertainment request, an activity request, a service request, a room service request, a social interaction request, an advertisement request, a message request, a housekeeping request, a wake up request, a weather request, a local information request, a hotel information request, an account information request, a billing request, a special offer request, a survey request, a games request, a medical request, a communication request, an email request, a golf reservation request, a restaurant reservation request, and a check out request; and wherein the facility service provider comprises at least one of a service provider located within the facility, a service provider located within the second facility, a service provider located near the facility, a service provider located near the second facility, and a service provider located externally to the facility and the second facility.

11. The method of claim 9, further comprising displaying, on the user terminal, at least one of a housekeeping icon, a wake up call icon, a room service icon, a weather icon, a hotel information icon, a special offers icon, a survey icon, an entertainment icon, a user information icon, a user account icon, a messages icon, an email icon, a languages icon, a social interaction icon, a telephone icon, an Internet icon, and a games icon.

12. The method of claim 3, wherein at least one of the first user-specific information, the second user-specific information and the other information comprise at least one of aggregated information assembled from a plurality of users and a plurality of facilities, information based at least in part on a location of the facility, information based at least in part on a location of the second facility, information based at least in part on a location of a third facility, and information based at least in part on at least one of a guest characteristic, a previous guest selection, a specified guest preference, a guest entertainment choice, a guest entertainment preference, a housekeeping request, a wake up request, a room service request, a restaurant option, a show option, an electronic games option, a movie option, a club option, a local entertainment option, weather information, hotel information, news information, health information, diet information, medical information, transportation information, personal services information, social interaction information, entertainment information, golf information and television information.

13. An electronic concierge system, comprising:
a server configured to communicate server information to at least one user terminal, wherein the at least one user terminal is configured to display the server information; and
a network connection configured to receive a user request from a specific user terminal and transmit user terminal information to the specific user terminal in response to the user request, wherein the user terminal information is based at least in part on aggregated user information associated with a plurality of users, and wherein the user terminal information is configured to be displayed on the specific user terminal.

14. The system of claim 13, wherein the server is further configured to communicate with at least one remote server, the system further comprising a second network connection configured to receive a server update from the at least one remote server, wherein the server update comprises the aggregated user information.

15. The system of claim 14, wherein at least one of the network connection and the second network connection comprises at least one of a wired network connection, a wireless network connection, a satellite network connection, a radio frequency network connection, a Bluetooth network connection, an Internet network connection, a telephone network connection, an Ethernet network connection, a cable network connection, and a coaxial network connection.

16. The system of claim 13, wherein the server information comprises at least one of housekeeping information, wake up information, room service information, weather information, hotel information, special offers information, survey information, entertainment information, guest information, guest account information, messages information, email information, Internet information, language information, telephone information, and games information.

17. The system of claim 13, further comprising a third network connection, wherein the server is configured to communicate with at least one user service provider via the third network connection, wherein the server is configured to receive a user service request from the at least one user terminal and transmit the user service request to the at least one user service provider, and wherein the at least one user service provider is selected based on the at least one user service provider's proximity to the at least one user terminal.

18. The system of claim 13, wherein at least part of the electronic concierge system is located in at least one of a hotel, a sports venue, a hospital, a shopping center, a community facility, an entertainment facility, a restaurant, and an airport.

19. The system of claim 13, wherein the at least one user terminal comprises at least one of a speaker, a microphone, a telephone, a camera, a USB port, an MP3 player input, a processor, a memory, a database, a network communications device, an operating system, a storage medium, and a touch screen, and wherein the at least one user terminal is configured to display the server information via at least one of a television, a liquid crystal display monitor, a cathode ray tube monitor, sound waves, a plasma screen, a computer monitor, and a handheld device.

20. A computer-readable medium having stored thereon a plurality of instructions, the plurality of instructions comprising:
instructions to aggregate first user-specific information and other information to create recommendation information;
instructions to associate the recommendation information with facility information;
instructions to provide a first user option in response to the instructions to associate the recommendation information with the facility information;
instructions to receive a first user selection in response to the instructions to provide the first user option;
instructions to update the first user-specific information in response to the instructions to receive the first user selection;
instructions to update the other information in response to the instructions to receive the first user selection;
instructions to aggregate second user-specific information and the other information to create second recommendation information;
instructions to associate the second recommendation information with second facility information;
instructions to provide a second user option to a second user in response to the instructions to associate the second recommendation information with the second facility information;
instructions to receive a second user selection in response to the instructions to provide the second user option;
instructions to update the second user-specific information in response to the instructions to receive the second user selection; and
instructions to update the other information in response to the instructions to receive the second user selection.
